(19) United States
(12) Patent Application Publication
(10) Pub. No.: US 2008/0275963 A1
(43) Pub. Date: Nov. 6, 2008

(54) Dynamically Modifying A Universal Resource Indicator

(76) Inventor: Joseph Aaron Hatfield, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/744,585

(22) Filed: May 4, 2007

(51) Int. Cl. G06F 15/16

(52) U.S. Cl. 709/218

(57) ABSTRACT

A logic module receives a navigation request that includes an address identifying a resource stored at a remote server. The logic module determines whether the address is valid based on predetermined criteria. If the address is valid, the logic modifies the address to include values that indicate a device configuration of the user terminal. The logic then causes the address to be sent to the remote server. Upon receipt, the remote server retrieves and returns the resource to the user. The content of the resource is determined based on the indicators.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present application relates generally to computing devices, and more particularly, to a network architecture for presenting a user with information.

2. Description of the Related Art

The World Wide Web provides access to a massive amount of interlinked resources via a worldwide, publicly accessible, interconnected network of computers called the Internet. Almost any user with a computing device and some appropriate browser and communication software can access the Internet to request and download a resource. Different resources are typically stored at different interconnected servers called hosts; however, navigating the Internet to locate a specific resource can be tricky given the complexity of the Internet. Therefore, various standards have emerged to facilitate users locating, accessing, and consuming the resources.

One such standard is RFC 3986/STD66 and is titled, “Uniform Resource Identifier (URI): Generic Syntax.” RFC 3986, which is dated January 2005 and authored by T. Berners-Lee, et. al., details the rules for naming a resource and is expressly incorporated herein by reference. Briefly, a Universal Resource Identifier (URI) is a string of characters used to identify a resource. The URI syntax generally comprises two parts—the “scheme name” and a “hierarchical” part. The scheme name is a sequence of characters consisting of a letter followed by any combination of letters, numbers, and/or other characters, and is terminated by a colon. The scheme name refers to a set of rules for assigning identifiers to the hierarchical part. The hierarchical part usually specifies a server and a base path where the resource is stored. Additionally, the hierarchical part may also include optional “query” and/or “fragment” strings for providing additional information about a resource. Query strings are particularly useful as they allow a server to provide specific content to a user.

Generally, URIs may be generated manually or automatically. Manual generation, which requires the user to type the URI string into an appropriate browser field, is extremely tedious and prone to error. Automatic generation relieves the user from having to manually enter potentially long strings, but requires downloading specialized scripts from a server so that they may be executed on the user's local device. However, this method is subject to latency delays and to the security limitations imposed by whatever browser software the user employs.

### SUMMARY

In one embodiment, a user's computing device has a browser that allows the user to navigate a communication network (e.g. the Internet) and view resources (e.g., web pages) on the communication network. Upon receipt of a navigation command, the browser invokes a logic module that examines the Uniform Resource Locator (URL) specified in the navigation request and modifies the URL if certain criteria are met. In one embodiment, the logic module determines whether the specified address contains certain predetermined “tags” or other required elements. If the specified URL lacks the required tags, the logic module modifies the URL received with the navigation request to include the required tags.

In one exemplary embodiment, information about the configuration of the user's equipment is stored in configuration files on the user's computer. When the user navigates to the web page maintained by the manufacturer of the user's equipment, the logic module may require that the URL include tags that describe the configuration of the user's equipment (e.g., type of printer, scanner, etc.). If the specified address lacks the required tags, the logic module may access the configuration files to retrieve information about the user's equipment, generate the required tags, and append the tags to the URL. Thus, when the web page is displayed, the content of the web page can be customized to provide information about the user's equipment.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram illustrating a network of a type suitable for use in one embodiment;

FIG. 2 is a block diagram of an exemplary computing device;

FIG. 3 is a flow chart illustrating how a user requests and receives resources according to the prior art;

FIG. 4 is a flow chart illustrating how a user could request and receive resources according to one embodiment;

FIG. 5 is a block diagram illustrating an architecture according to one embodiment;

FIG. 6 is a flow chart illustrating how one embodiment operates to customize a Uniform Resource Locator (URL);

FIG. 7 is a block diagram illustrating an architecture according to one embodiment; and

FIG. 8 is a flow chart illustrating how another embodiment operates to customize a Uniform Resource Locator (URL).

### DETAILED DESCRIPTION

In one embodiment, a user's computing device executes browser software to access, download, and view desired resources from the Internet. Before navigating to a resource such as a web page, for example, code associated with the browser software intercepts a Uniform Resource Locator (URL) of the web page. Based on the current state of the URL, and on one or more current hardware and/or software configurations of the user's computing device, the code dynamically generates a new URL and returns it to the browser. The browser then sends the generated URL to a server via a communication network, such as the Internet, and displays the results. The generated URL includes information that permits the server to return content that is more focused to the user's anticipated needs.

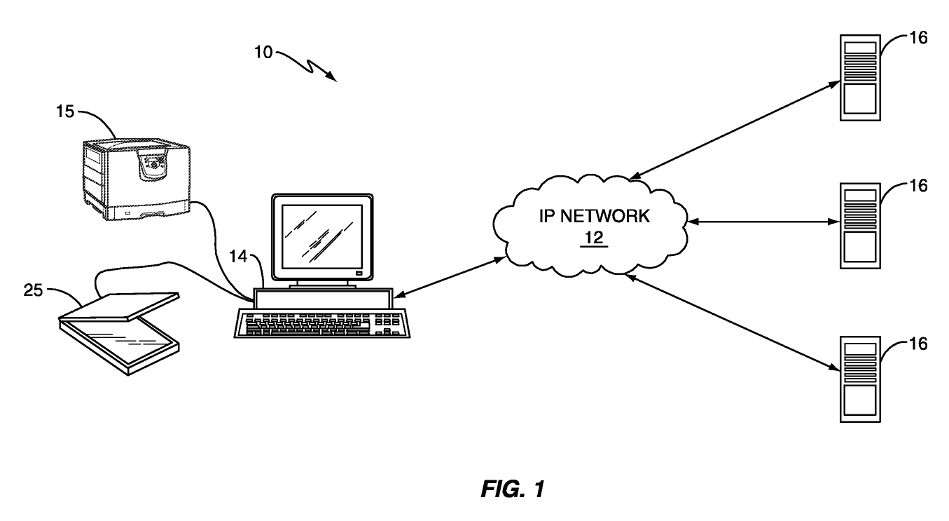

FIG. 1 is a block diagram that illustrates a system 10 suitable for use with the architecture configured according to one embodiment of the present invention. System 10 is a data communication system comprising a network 12 that interconnects a user terminal 14 with one or more remote servers 16. Generally, system 10 allows the user of user terminal 14 to request information and data stored on the servers 16. Such information includes, but is not limited to, text documents, images, video, music, as well as other multimedia.

Network 12 may be any Internet Protocol (IP) based computer network capable of communicating data and other information between user terminal 14 and servers 16. Network 12 may comprises a Local Area Network (LAN) or a wide area network (WAN) (e.g., Internet), and may be a public or private network. The network 12 may use any communication medium, such as cable, optical fiber, radio carriers, etc., or any combination thereof.

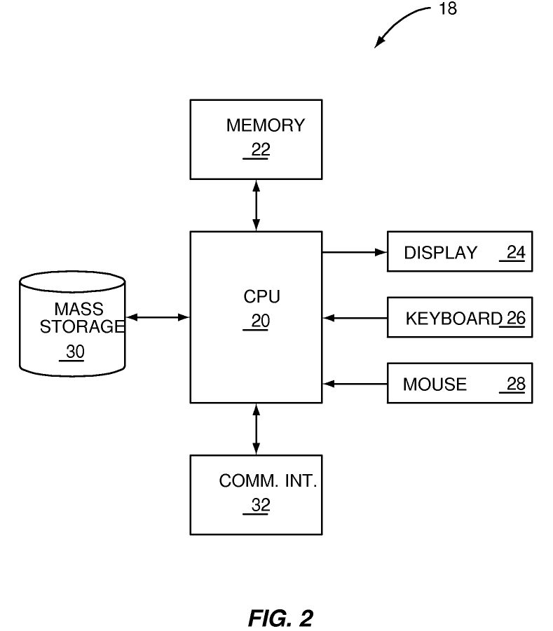

FIG. 2 illustrates a computing device 18 that may function as either a user terminal 14 or server 16. For use as a server, the computing device 18 will typically comprise a desktop computer with a fixed connection to the network 12. For use as a user terminal 14, the computing device 18 may comprise a desktop computer or laptop computer with a fixed connection to the network 12, or a mobile computing device (e.g., laptop computer, PDA, mobile phone, etc.) with a wireless connection to the network 12. The computing device 18 comprises a central processing unit (CPU) 20 and memory 22 arranged to execute software, such as a web browser or web server. A display 24 provides a visual output for viewing by a user. User input devices, such as keyboard 26 and mouse 28, enable a user to input commands and data into the CPU 20. As is known in the art, application programs may display a graphical user interface on the computer display 24, and the user may interact with the graphical user interface using the keyboard 26, mouse 28, and/or other user input devices. Computing device 18 further include a mass storage device 30 such as a magnetic disk drive or optical disk drive, and a communication interface 32 for communicating with remote devices over a communication network. The communication interface 32 may, for example, comprise an Ethernet interface, a serial interface (e.g., USB), a parallel interface (e.g. Firewire), or a wireless interface (e.g., Bluetooth, WiFi).

The computing device 18 used as a user terminal 14 may further include one or more peripheral devices, such as a printer 15 and scanner 25 that connect through a peripheral interface (e.g., USB interface). However, this configuration of the user terminal 14 is for illustrative purposes only. The user terminal 14 may include other peripheral devices in addition to or in place of the illustrated printer 15 and scanner 25.

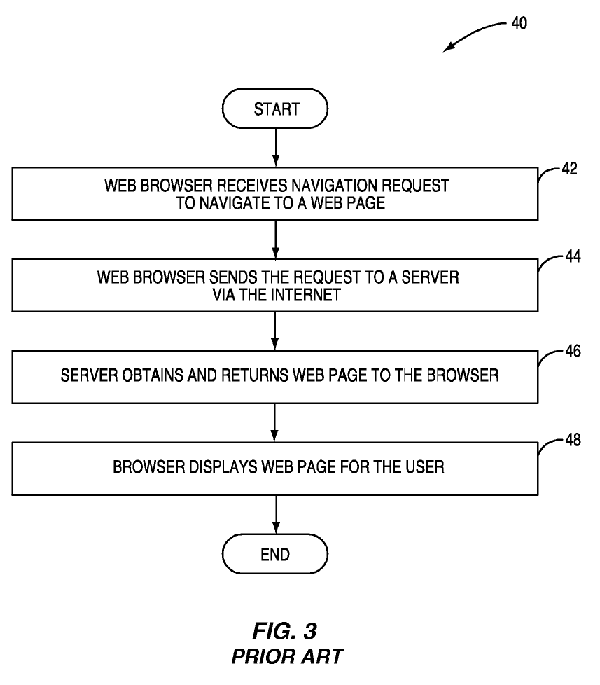

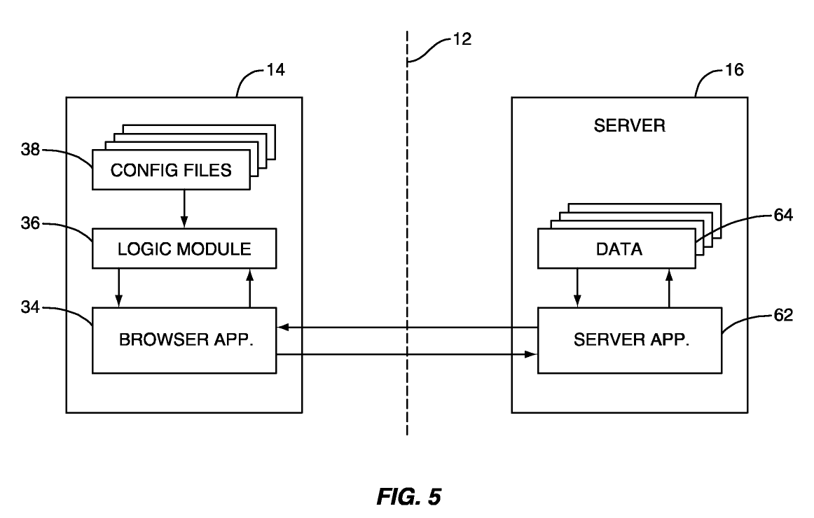

FIG. 3 illustrates an exemplary method 40 for modifying resource requests sent by a browser application 34 (FIG. 5) on a user terminal 14 to a web server application 62 (FIG. 5) on a server 16. The process begins with the user entering a URL for a desired web page (e.g., http://www.lexmark.com) into a browser application 34, such as MICROSOFT'S INTERNET EXPLORER (box 42). Alternatively, the user may follow a hypertext link to the web page. As is known in the art, the browser application 34 resolves the server name part of the URL into an IP address, and establishes a connection with the desired server 16. Once connected, the browser application 34 sends a HyperText Transfer Protocol (HTTP) request to the server 16 to request the web page (box 44). Upon receipt of the information, the server application 62 parses the HTTP request, retrieves the desired resource, and returns the information to the browser application 32 (box 46). Usually, the information returned to browser application 32 is formatted according to the well-known HyperText Markup Language (HTML) or one of its functional equivalents. The browser application 32 then parses the data received from the server 16 and renders the web page on a display 24 of the user terminal 14 (box 48).

The method of FIG. 3 is useful; however, it may not be as efficient in providing the user with information as it should. Specifically, most servers present a flood of information to the user that is often times overwhelming. Some servers will allow users to configure their preferences to define information specific to their needs. However, these methods require a human to actively define the bounds of what a server should return. As the user's needs change from time to time, the user will need to redefine the bounds. Some users may not be savvy enough to provide this type of information to the browser.

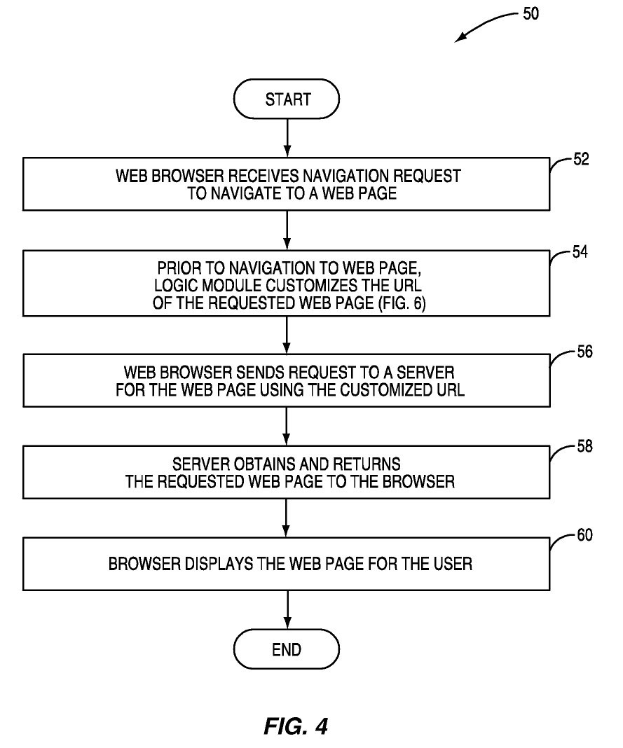

FIG. 4 is a flow diagram of one embodiment that addresses these issues presented by conventional architectures. Method 50 begins when the web browser receives a navigation request from the user (box 52). As above, the navigation request includes a manually entered URL of a web page, or is a URL associated with a hypertext link selected by the user. Prior to navigating to the web page, a logic module 36 (FIG. 5) communicating with the browser application 34 generates a customized URL (box 54). The customized URL will include data that will cause the server application 62 to return content that is focused on the user's anticipated needs. The browser application 32 then sends a request to the server application 62 using the customized URL (box 56). Upon receipt, the server application 62 obtains information based on the data included with the customized URL (box 58) and returns it to the user's web browser for display (box 60).

FIG. 5 is a block diagram illustrating a user terminal 14 communicating with server 16 via network 12 to request and receive focused content according to one embodiment. User terminal 14 comprises a browser application 34, a logic module 36, and one or more configuration files 38. Browser application 34 is a web browsing software application that enables the user to request, display, and interact with information provided by server 16, such as a web page. Browser application 34 communicates with server application 62 on server 16 using HTTP to request and receive data 64 including, but not limited to, web pages, text documents, images, video, audio, and streaming media. Browser application 34 is also capable of supporting and communicating with other computer programs, such as add-ons, plug-ins, and browser extensions, using event notifications. Some well-known examples of web browsers 34 suitable for use in the various embodiments are INTERNET EXPLORER, NETSCAPE, SAFARI, and FIREFOX; however, other browsers not specifically listed here are also suitable.

Logic module 36 comprises a computer program that communicates with and interacts with browser application 34 using any inter-process communication method known in the art. Alternatively, the function of the logic module 36 can be included in the browser application 34. Because different browsers 34 use different technology, there are a variety of communication mechanisms by which browser application 34 and logic module 36 can communicate and exchange information and commands. For example, some embodiments employ an Application Programming Interface (API) to facilitate communication between logic module 36 and browser application 34. Other embodiments use MICROSOFT'S Component Object Model (COM); however, other communication mechanisms are also available and are equally as suitable as those specifically mentioned here.

Logic module 36 comprises a set of instructions that, depending on the browser application 34, may be referred to as an “add-on,” an “extension,” or a “plug-in,” for example. Logic module 36 may be created using C, C++, Java, or any programming language known in the art. In operation, logic module 36 receives URLs from the browser application 34. Logic module 36 then tests the URL based on predetermined criteria to determine whether the URL is formatted to retrieve data focused on the user's anticipated needs. If not, the logic module 36 customizes the URL, or generates a new URL, such that it is formatted to retrieve such focused data. Logic module 36 then returns the URL to the browser application 34 for continued processing and forwarding to server 16. While logic module 36 processes the URL, logic module 36 may also send commands to the browser application 34 to control how browser application 34 communicates with server application 62 on server 16.

The configuration files 38 comprise one or more files stored in memory 22. Configuration files 38 may contain configuration data in text or binary format, and are created whenever a user installs a peripheral device such as printer 15 and/or scanner 25. The configuration data comprises information about the peripheral device, such as the make and model of the peripheral device, and the firmware and/or software versions of the peripheral device. In operation, the logic module 36 may retrieve the configuration data from these configuration files 38, and use the configuration data to generate and/or customize URLs received from the browser application 34 as hereinafter described.

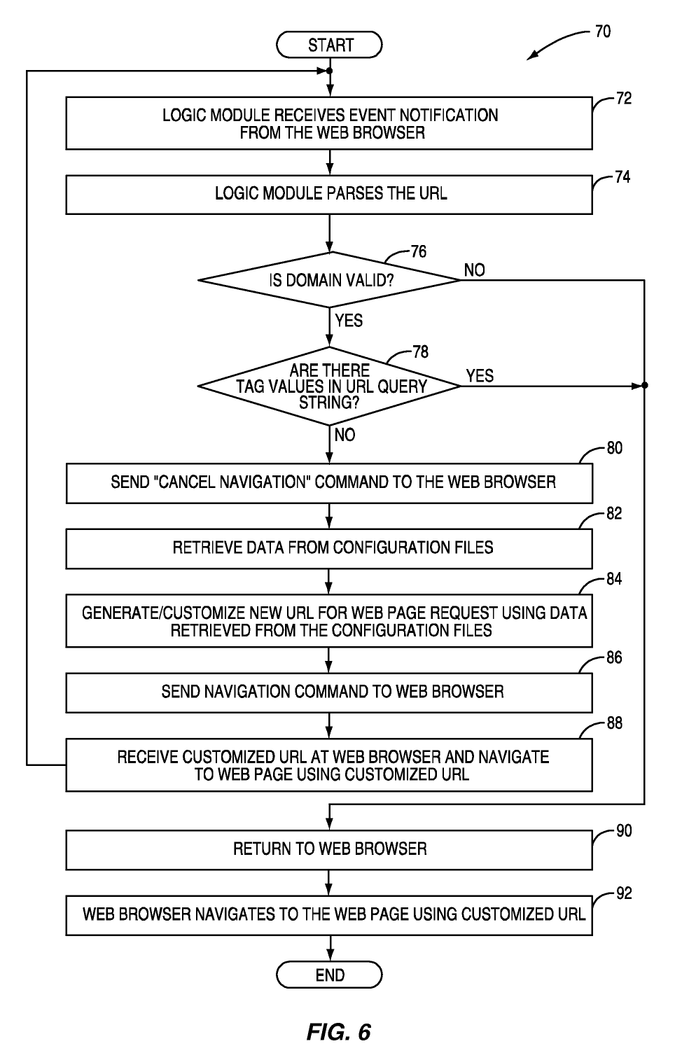

FIG. 6 is a flow diagram illustrating an exemplary method implemented by the logic module 36 for customizing the URL specified in a navigation request to the browser application 34. For illustrative purposes only, method 70 assumes that browser application 34 is MICROSOFT'S INTERNET EXPLORER, and that the user has entered “http://www.lexmark.com/” as the specified URL.

Method 70 begins when logic module 36 receives an event notification from browser application 34 of a pending navigation event (box 72). For example, an IE browser may expose the pending navigation event to the logic module 36 using the well-known DWebBrowserEvents2::BeforeNavigate2 event. The browser application 34 triggers this event before navigation occurs, and includes information in a variety of different event fields. An example of the event notification syntax appears below in Listing 1.

Listing 1: BeforeNavigate2 Event

```
void BeforeNavigate2(
      IDispatch *pDisp,
      VARIANT *&url,
    VARIANT *&Flags,
VARIANT *&TargetFrameName,
    VARIANT *&PostData,
    VARIANT *&Headers,
  VARIANT_BOOL *&Cancel
        );
```

The event field *pDisp, which is populated by the browser application 34, points to an IDispatch interface that is part of logic module 36. The IDispatch interface includes an event handler that receives and processes the event notifications of many different events received from the browser application 34. Each event received by the IDispatch interface is associated with a unique event ID. Upon receipt of the event ID, the IDispatch interface of the logic module 36 executes the computer code associated with the event ID.

In one embodiment, logic module 36 receives an event notification having the value DISPID_BEFORENAVIGATE2 as the event ID. The *&url event field points to the URL entered by the user. Upon receipt, the logic module 36 parses the URL to determine whether it is properly formatted to retrieve information that the user is most likely interested in. In FIG. 6, this determination comprises a two-part, predetermined test; however, other tests may also be used.

First, the logic module 36 parses the URL (box 74) and determines whether the URL includes a valid domain name. In the above example, the domain name comprises “lexmark.com.” Validating the domain name ensures that non-trusted domains, such as those that belong to competitive entities, do not exploit the invention and receive the user's information. If the domain is not valid (box 76), the logic module 36 simply returns control to the browser application 34 (box 90), which then navigates to the web page defined by the URL (box 92). If the domain is valid, however (box 76), the logic module 36 performs the second test.

In this second test, the logic module 36 determines whether the URL is formatted to provide the server 16 with information detailing the user's anticipated needs (box 78). In this embodiment, that determination is accomplished by examining the URL to check if it includes one or more tags and associated values. The tags and values, which may be derived from the configuration files 38, are of the form:

d˜[tag]=value

The “[tag]” portion indicates a particular item, such as printer 15 or scanner 25, while the “value” portion identifies a particular make or model of the item. The tags and values would be included in the query string portion of the URL. If the tags and values are in the query string, the logic module 36 will simply return control to the browser application 34 (box 90), which then navigates to the web page defined by the URL (box 92). If the tags and values are not in the query string (box 78), the logic module 36 will customize the URL, or generate a new URL, to include the appropriate tags and values.

Particularly, the logic module 36 may first send a command to browser application 34 to stop browser application 34 from navigating to the web site (box 80). This may be accomplished, for example, by sending a BeforeNavigate2 to the browser application 34. The logic module 36 could populate the pDisp event field to point to an IDispatch interface at the browser application 34, and set the *&Cancel event field to the value TRUE. Upon receipt, the event handler at the browser application 34 would execute code to cancel the navigation attempt to the URL pointed to by the *&url event field. The logic module 36 may then access the configuration files 38 to retrieve information and data associated with the peripherals connected to user terminal 14 (box 82). Based on this information, the logic module 36 will customize the URL originally received from the browser application 34 to include the appropriate tags and values, or alternatively, generate a new URL to include the appropriate tags and values (box 84).

As one example, consider the URL “http://lexmark.com” originally received by logic module 36. In this state, the URL includes only the domain name, which for clarity, is assumed to be valid. The logic module 36 could retrieve information from the configuration files 38 indicating that the user has a printer 15. In that case, the logic module 36 would customize the originally received URL by adding a tag and a value indicative of the type of the user's printer 15 to the query string. By way of example, the URL might be modified to appear as:
http://www.lexmark.com/home.asp?lang=en&d˜printers=42

Similarly, if logic module 36 determines that the user also has a scanner 25, the logic module 36 could modify the URL to appear as:
http://www.lexmark.com/home.asp?lang=en&d˜printers=42&d˜scanners=17

Additional tags and values may be added to the query string as needed or desired.

Once the URL is customized or generated, the logic module 36 sends a navigation command to control the browser application 34 (box 86). The browser application 34 receives the customized URL and uses the customized URL to navigate to the web page using the new URL (box 88). For example, the logic module 36 may send a second BeforeNavigate2 to the browser application 34 wherein *pDisp points to the IDispatch interface at browser application 32, and *&url points to the customized or generated URL. The logic module 36 also sets *&Cancel to FALSE. Upon receipt, the event handler at the browser application 34 would execute code to re-start the navigation attempt to the new URL pointed to by *&url.

However, sending the command to navigate to browser application 34 using the new URL will force a second pass of the URL through the logic module 36. Particularly, the browser application 34 will again send a BeforeNavigate2 event to the logic module 36 with *pDisp pointing to the IDispatch interface and *&url pointing to the customized URL. As above, the logic module 36 will parse the URL upon receipt of the event notification and check the URL (boxes 72, 74, 76). In this second pass, the customized URL would include a valid domain name, but already include a set of tags and values (box 78). Having the query string would indicate that the URL was already customized. This would then force the logic module 36 to return control to browser application 34 to navigate to the web page (boxes 90, 92) and prevent an infinite loop condition. The server application 62 at server 16 could then use the tags and values in the customized URL to retrieve information related to printer 15 and/or scanner 25 for the user.

Although the browser application 34 may provide the customized URL to the logic module 36 for a second pass, this is not required. The logic module 36 could alternatively append a predetermined indicator to the customized URL during the first pass that would indicate to the browser application 34 that the URL is customized. The browser application 34 could then skip the second pass to the logic module 36 and continue navigating based on the customized URL. However, while this may reduce processing, it would require code modifications to the browser application 34 to recognize and handle the predetermined indicator.

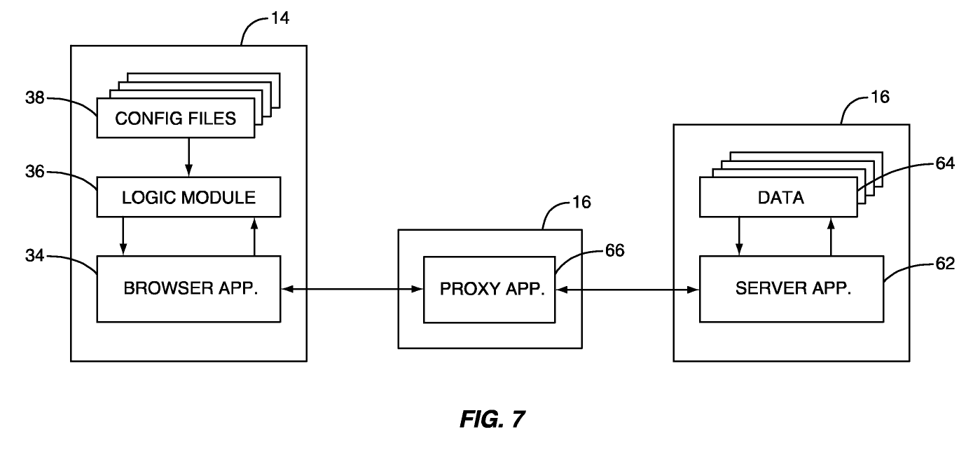

FIG. 7 illustrates another embodiment in which a proxy application 66 receives the navigation request from the browser application 34 and generates a modified URL. The proxy application 66 may reside on the same server 16 as the server application 62, or may reside on a different server 16.

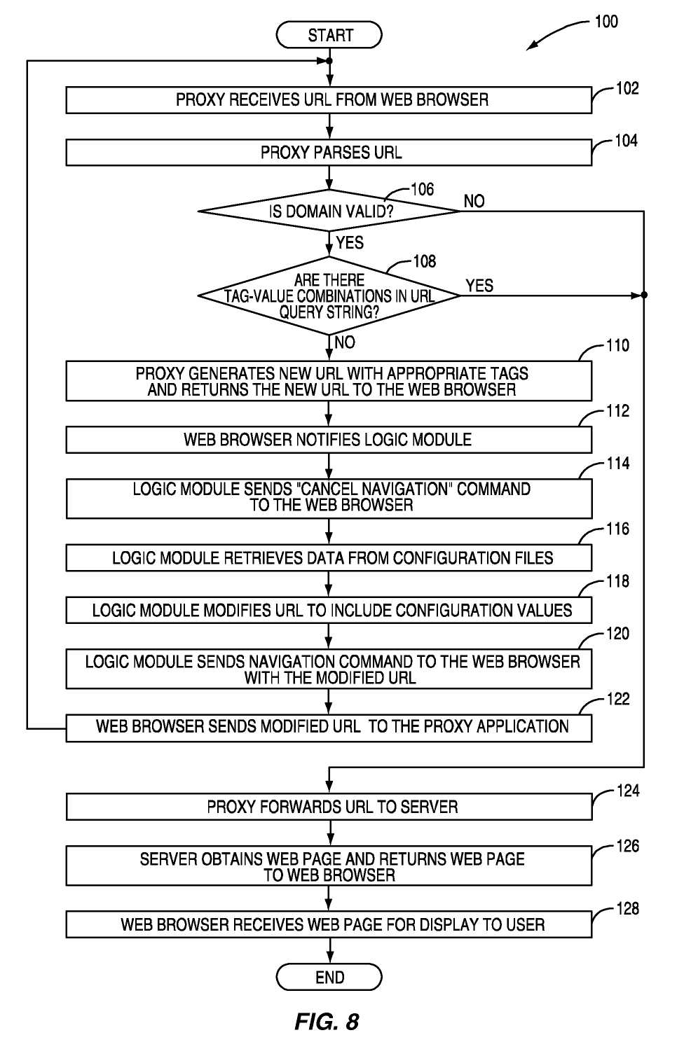

FIG. 8 illustrates a method 100 implemented in this embodiment. It is assumed for illustrative purposes that browser application 34 is MICROSOFT'S INTERNET EXPLORER, and that the user has entered “http://www.lexmark.com/” as the URL into the browser application 34. Method 100 begins when the proxy application 66 receives the URL from browser application 34 (box 102). Upon receipt, browser application 34 parses the URL and executes the two-part test mentioned above (boxes 104, 106, 108). If the domain name is not valid (box 106) or the URL already includes one or more tag-value combinations in the query string (box 108), the proxy application 66 forwards the navigation request to the server application (box 124). The server application retrieves the requested web page and returns it to browser application 34 for display to the user (boxes 126, 128). However, if the domain is valid, and if the URL has not already been customized by placing the tag-value combinations in the query string (boxes 106, 108), the proxy application 66 will generate a modified URL and return it to browser application 34 (box 110). In this embodiment, the proxy application 66 will not populate the query strings with the appropriate values, but instead, will simply generate a query string with one or more empty tags. As described in more detail below, the logic module 36 will populate the tags in the query string with the proper values. An example of the generated URL returned to the browser application 34 appears below:
http://www.lexmark.com/home.asp?lang=en&d˜printers=&d˜scanners=

Upon receipt, browser application 34 notifies logic module 36 as previously described. However, the browser application 34 sets the *&url pointer to point to the modified URL received from the proxy application 66 (box 112). As in the previous embodiment, the logic module 36 sends a “cancel” command to browser application 34 (box 114), retrieves the information from the configuration files 38 (box 116), and populates the tags in the modified URL to include the appropriate values (box 118). In one embodiment, for example, the user terminal 14 may only have printer 15, but not scanner 25. In such cases, the logic module 36 would modify the URL to include a printer value, but remove the “&dscanner” tag from the query string. An example of such a URL appears below:
http://www.lexmark.com/home.asp?lang=en&d˜printers=42

Similarly, logic module 36 may only populate the scanner tag to identify scanner 25 but remove the printer tag if the user does not have printer 15. In cases where the user does not have any peripheral devices, the logic module 36 may modify the URL to comprise a predetermined indicator to indicate to the proxy application 66 that the user does not have any peripheral devices. The indicator may be, for example, a special tag and value combination that causes the proxy application 66 to retrieve a default set of data 64, such as the home page of the URL, for return to the user terminal 14. An example of such a URL might appear as:
http://www.lexmark.com/home.asp?lang=en&d˜devices=−1

The logic module 36 then sends a navigation command to browser application 34, for example, the BeforeNavigate2 event with *&url pointing to the modified URL, to cause the browser application 34 to retrieve the desired web page (box 120). The browser application 34 then sends the navigation request with the modified URL to the proxy application 66 (box 122). Upon receipt, the proxy application 66 parses the URL (box 104). The server application 62 again checks the URL to determine if the domain is valid (box 106) and if the URL includes a query string having tag-value combinations (box 108). In this case, the domain is valid and the URL includes a query string that comprises tag-value combinations. Therefore, the proxy application 66 forwards the request to the server application 62. The server application 62 retrieves the requested web page and returns it to browser application 34 for display to the user (boxes 124, 126).

It should be noted that the two-part test for preventing infinite loop conditions at the logic module 36 and at the proxy application 66 are illustrative only. Those skilled in the art will appreciate that any desired criteria may be used to prevent such conditions. Also, those skilled in the art will recognize that the function of the proxy described above can be incorporated into the server application 62.

The present application may be carried out in other ways than those specifically set forth herein without departing from essential characteristics of the application. The present embodiments are to be considered in all respects as illustrative and not restrictive, and all changes coming within the meaning and equivalency range of the appended claims are intended to be embraced therein.

What is claimed is:

1. A method implemented by a user terminal of requesting a resource from a remote server, the method comprising:
determining whether a Uniform Resource Locator (URL) contained in a navigation request meets a predetermined criterion; and
modifying the URL to include one or more indicators that identify a device configuration of a user terminal if the URL meets the predetermined criterion.

2. The method of claim 1 wherein determining if the URL meets a predetermined criteria comprises determining whether the URL comprises a qualified domain name.

3. The method of claim 2 wherein determining if the URL meets a predetermined criteria comprises determining whether the URL includes the one or more indicators that indicate the device configuration.

4. The method of claim 1 wherein modifying the URL to include one or more indicators comprises:
generating a command to cancel navigation initiated by the navigation request if the URL meets the predetermined criteria;
retrieving device configuration information from memory; and
modifying the URL to include a query string comprising indicators determined based on the device configuration information.

5. The method of claim 4 wherein modifying the URL to include the query string comprises adding the one or more indicators to the query string.

6. The method of claim 5 wherein the indicators include one or more tags having values that indicate the device configuration.

7. The method of claim 1 further comprising generating a navigation request including the modified URL, and retrieving the resource identified by the modified URL.

8. The method of claim 7 wherein the resource comprises a web page, and wherein the one or more indicators control the web page content.

9. A computer-readable medium comprising code stored thereon for controlling operation of a computing device, said code comprising:
code to determine whether a Uniform Resource Locator (URL) contained in a navigation request meets a predetermined criterion; and
code to modify the URL to include a query string comprising one or more indicators that identify a device configuration if the URL meets the predetermined criteria.

10. The computer readable medium of claim 9 wherein the code further comprises code to generate a cancel navigation command to terminate the navigation request.

11. The computer readable medium of claim 10 wherein the code further comprises code to generate a new navigation request including the modified URL, and to send the new navigation request to a browser application to retrieve the resource based on the modified URL.

12. The computer readable medium of claim 9 wherein the code to determine whether a Uniform Resource Locator (URL) contained in a navigation request meets a predetermined criterion comprises:
code to determine whether the URL received with the navigation request comprises a qualified domain name; and
code determine whether the URL includes the one or more indicators that identify a device configuration.

13. The computer readable medium of claim 10 wherein the URL identifies a web page, and wherein the one or more indicators control the web page content retrieved for the user.

14. A computing device comprising:
memory to store a device configuration; and
a central processing unit configured to:
determine whether a Uniform Resource Locator (URL) contained in a navigation request meets a predetermined criterion, said URL identifying a resource of a remote server; and
modify the URL to indicate the device configuration to the remote server if the URL meets the predetermined criterion.

15. The computing device of claim 14 wherein the central processing unit determines if the URL meets a predetermined criteria by determining whether the URL comprises a qualified domain name.

16. The computing device of claim 14 wherein the central processing unit determines if the URL meets a predetermined criteria by determining whether the URL includes the one or more indicators that identify a device configuration.

17. The computing device of claim 16 wherein the one or more indicators comprise one or more values that identify one or more peripheral devices.

18. The computing device of claim 14 wherein the central processing unit modifies the URL by:
generating a command to cancel navigation initiated by the navigation request if specified URL meets the predetermined criteria;
retrieving device configuration information from memory; and
inserting indicators determined based on the device configuration information into the URL.

19. The computing device of claim 18 wherein the central processing unit inserts a query string with said indicators into the URL.

20. The computing device of claim 19 wherein the indicators include one or more tags having values that indicate the device configuration.

21. The method of claim 14 wherein the resource comprises a web page, and wherein the one or more indicators control the web page content.

22. The computing device of claim 21 wherein the central processing unit is further configured to generate a new navigation request including the modified URL.

23. The computing device of claim 22 wherein the central processing unit is further configured to execute a browser application to send the new navigation request having the modified URL to a remote server.
